(19) United States
(12) Patent Application Publication
(10) Pub. No.: US 2016/0218452 A1
(43) Pub. Date: Jul. 28, 2016

(54) BREAD BOARD, BREAD-BOARD SPECIFIC JUMPER WIRE, AND EDUCATION KIT

(71) Applicant: Korea University Research and Business Foundation, Seoul (KR)

(72) Inventor: Sughui Kim, Seoul (KR)

(73) Assignee: Korea University Research and Business Foundation, Seoul (KR)

(21) Appl. No.: 15/005,444

(22) Filed: Jan. 25, 2016

(30) Foreign Application Priority Data
Jan. 28, 2015 (KR) 10-2015-0013393

(51) Int. Cl. H01R 9/22; H01R 13/62

(52) U.S. Cl. CPC H01R 9/22; H01R 13/6205

(57) ABSTRACT

Disclosed is a bread board including a metal layer joinable with a magnet, an insulation layer placed on the metal layer, and a plurality of conductive pads placed on the insulation layer, thus allowing a user to intuitively know a circuit connection state of the bread board and to easily form a circuit.

### CROSS-REFERENCE TO RELATED APPLICATIONS

A claim for priority under 35 U.S.C. §119 is made to Korean Patent Application No. 10-2015-0013393 filed Jan. 28, 2015, in the Korean Intellectual Property Office. The entire contents of this application are hereby incorporated by reference.

### BACKGROUND

1. Statement of Technical Field

The present disclosure relates to a bread board, a bread-board specific jumper wire, and an education kit. More particularly, the present disclosure relates to a bread board, a bread-board specific jumper wire, and an education kit which allow a beginner to intuitively know a circuit connection state of the bread board and to easily form a circuit.

2. Description of Related Art

Bread boards are well known. Bread boards are generally employed to fabricate a non-soldering electronic circuit sample. Bread boards are essential for engineers engaging in the industry of electronic and electric circuits. Bread boards are also called bread plates. A circuit in a bread board is formed using jumper wires and a connection configuration of the bread board. A bread board user forms a circuit with knowledge about the connection configuration of the bread board. Many circuit parts can be connected through jumper wires to form a specific circuit.

FIG. 1 shows a connection configuration in a known bread board. As shown in FIG. 1, specific areas A and D are connected with horizontally adjacent slots (holes) while other specific areas B and C are connected with vertically adjacent slots (holes).

Bread boards are generally utilized for education. Bread boards are used by beginners and students in education courses by software (SW) or hardware (HW). As shown in FIG. 1, beginners or students need to preliminarily know connection configurations of bread boards and need to consider other circuit part connections using jumper wires under knowledge about the connection configurations. This makes beginners or students inconvenient and much difficult in education. As the configuration of FIG. 1 is an internal connection configuration of a bread board, beginners cannot intuitively know the internal connection configuration. Although bread boards are advantageous in connecting chips thereto, it is difficult for beginners to complete circuit part connections in the case without chips. Therefore, there is a need of a bread board, a bread-board specific jumper wire, and an education kit which allow even a beginner to intuitively know a connection configuration of the bread board and facilitate a circuit formation through circuit part connection with the intuitively known connection configuration.

### SUMMARY

The present disclosure concerns a bread board, a bread-board specific jumper wire, and an education kit which allow a beginner to intuitively know connection configuration of the bread board and to easily form a circuit.

In some scenarios, a bread board may include a metal layer joinable with a magnet, an insulation layer placed on the metal layer, and a plurality of conductive pads placed on the insulation layer.

In those or other scenarios, a bread-board specific jumper wire may include a magnet terminal, a connection wire configured to conduct an electrical signal with the magnet terminal, and a connection terminal configured to conduct an electric signal with the connection wire.

In those or other scenarios, an education kit may include a bread board and a bread-board specific jumper wire, wherein the bread board may include a metal layer joinable with a magnet, an insulation layer placed on the metal layer, and a plurality of conductive pads placed on the insulation layer. The bread-board specific jumper wire may include a magnet terminal, a connection wire configured to conduct an electrical signal with the magnet terminal, and a connection terminal configured to conduct an electric signal with the connection wire.

In those or yet other scenarios, a bread board, a bread-board specific jumper wire, and an education kit may allow a beginner to intuitively know a circuit connection state of the bread board and then to easily form a circuit.

### BRIEF DESCRIPTION OF THE FIGURES

The above and other objects and features will become apparent from the following description with reference to the following figures, wherein like reference numerals refer to like parts throughout the various figures unless otherwise specified.

FIG. 1 shows a connection configuration of a known bread board.

FIG. 2 exemplarily shows an external pattern of a bread board.

FIG. 3 exemplarily shows a section of a bread board.

FIG. 4 exemplarily shows an external pattern of a bread board.

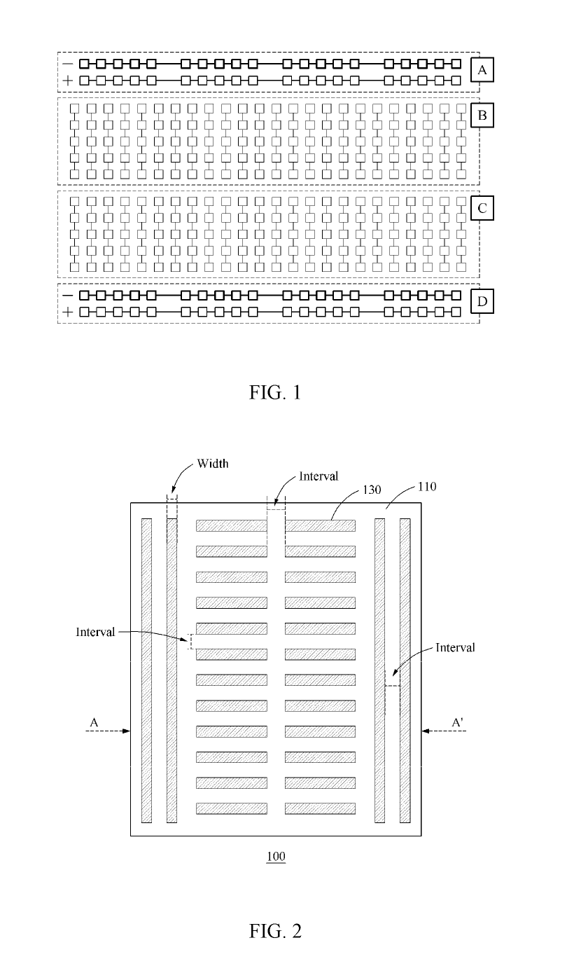

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

FIG. 2 exemplarily shows an external pattern of a bread board 100. As shown in FIG. 2, the bread board 100 may include an insulation layer 110 and a plurality of conductive pads 130 which are placed on the insulation layer 110 and are isolated each other.

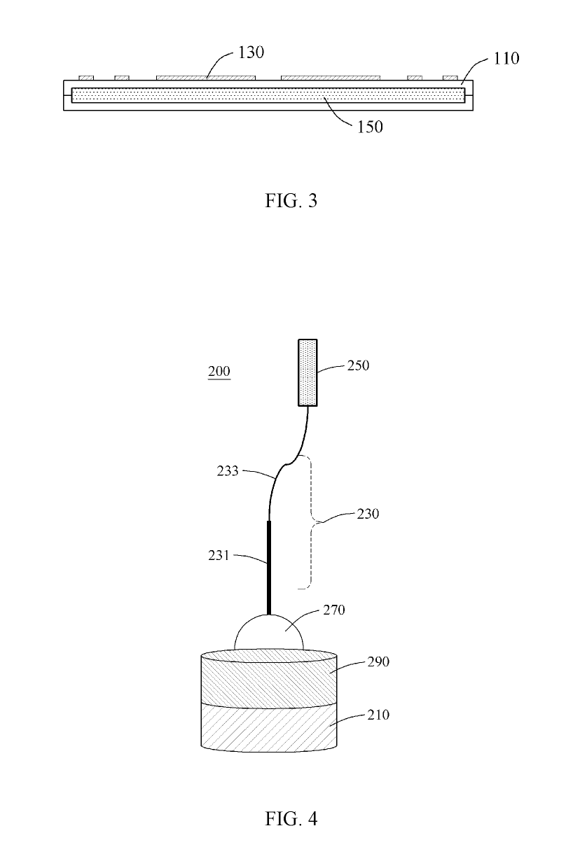

With respect to elements of the bread board 100, the insulation 110 may be formed of, for example, a plastic (plate) containing a component of synthetic resin and may isolate a metal layer 150, which will be described by FIG. 3, from the external. As such, the insulation layer 110 may be formed of a component through which an electric signal cannot be transferred.

The conductive pads 130 may be placed on the insulation layer 110 and may be directly joined with the insulation layer 110. For example, the conductive pads 130 may be attached to a plastic plate of the insulation layer 110 through a joining material (e.g., an adhesive). The conductive pads 130 may be formed of a highly conductive metal, e.g., nonferrous metal such as copper. The conductive pads 130 may be formed of a copper tape.

As can be seen from FIG. 2, a plurality of the conductive pads 130 may be shaped in lines. The conductive pads 130 may be formed to transfer electric signals between elements in circuit configuration of the bread board 100. Accordingly, two elements connected with the same one of the conductive pads 130 may exchange an electric signal each other. Electric signals of several conductive pads 130 may be transferred through elements connected with those several conductive pads 130.

A width of the conductive pad 130 may be preliminarily determined. For example, a width of the conductive pad 130 may be determined in proportion to a diameter or partial size of a magnet terminal 210 of a jumper wire 200 employed in the bread board 100, or its proportional size. Additionally, an interval between adjacent ones of the conductive pads 130 may be set larger than the diameter or partial size of the magnet terminal 210. A length of the conductive pad 130 may be variable dependent on a design of the bread board 100. For example, a specific group of the conductive pads 130 (the vertically arranged conductive pads 130 in FIG. 2) may be longer than the other group of the conductive pads 130 (the horizontally arranged conductive pads 130 in FIG. 2).

As an interval between the conductive pads 130 is formed larger than a size of a terminal of the jumper wire 200, it may be possible to prevent an inadvertent short-circuit of the conductive pads 130 in accordance with placement of the jumper wire 300.

As shown in FIG. 2, the plurality of conductive pads 130 may be directly exposed to a user. The user is able to intuitively know a basic configuration of connection of the bread board 100 from the arrangement of the conductive pads 130.

FIG. 3 shows a section of a bread board according to the inventive concepts. The section of FIG. 3 is taken by AA′ of FIG. 2. As can be seen from FIG. 3, the bread board 100 may further include a metal layer 150 therein. As also shown in FIG. 3, an insulation layer 110 may be placed on the metal layer 150 of the bread board 100. A plastic plate of the insulation layer 110 may be formed of a case (an implemental material) to protect the metal layer 150 from the external.

The metal layer 150 may include a metal joinable with a magnet. The metal layer 150 may be joined with an external magnet out of the insulation layer 110 through a metal component, which is well attachable to a magnet, to fix a jumper wire 200 and other elements of the inventive concepts to the bread board 100. The metal layer 150, for example, may be made of a tin plate containing tin, or an iron plate. The metal layer 150 may be preferably embedded in a case of the bread board 100 in a form of plate.

As such, for the purpose of connection with elements to be mounted thereon according to a circuit configuration, the bread board 100 may allow the jumper wire 200, which is equipped with a magnet terminal 210, to join with the metal layer 150 which is placed under a conductive pad 130.

FIG. 4 exemplarily shows a jumper wire for a bread board. The jumper wire 200 of FIG. 4 may be used in the bread board 100 shown in FIGS. 2 and 3. As shown in FIG. 4, the jumper wire 200 may include a magnet terminal 210, a connection wire 230, and a connection terminal 250. The jumper wire 200 may further include a solder 270 for connecting the magnet terminal 210 and the connection wire 230, and a metal terminal 290 placed between the solder 270 and the magnet terminal 210.

In regard to the configuration of the jumper wire 200 for the bread board 100, the magnet terminal 210 may be formed of a magnetic material through which the magnet terminal 210 is joined with the metal layer 150 of the bread board 200. The magnet terminal 210, for example, may be formed of a neodymium magnet. The magnet terminal 210 may be molded in a shape of cylinder or rectangular parallelepiped. A diameter of the magnet terminal 210 or a length of a specific plane of the rectangular parallelepiped may be utilized in setting a width (thickness) and an interval of the conductive pads 130 of the bread board 100.

The metal terminal 290 may be joined with the magnet terminal 210 to transfer an electric signal and to allow the solder 270 to be joined therewith through a soldering. The metal terminal 290 may be formed in the same pattern with the magnet terminal 210 and may be made of iron as a main component which is easy in transferring an electric signal and soldering. The metal terminal 290 may be excluded therefrom in accordance with a modification of the jumper wire 200.

The solder 270 comprised in jumper wire 200 may join the connection wire 230 with the magnet terminal 210 (directly or through the metal terminal 290) to allow electric signal transfer. The solder 270 may be formed by a soldering process. General lead may be even used to connect an electric wire with the magnet terminal 210. For a direct soldering to the magnet terminal 210, it needs to use a lead, which has a low melting point, in accordance with a component of the magnet terminal 210.

For example, in the case with a neodymium magnet, the magnetism is lost at temperature over 300° C. Accordingly, a soldering for joining the magnet terminal 210 with the connection wire 230 may be formed at a low melting point (e.g., 180° C.). For example, a low melting-point lead may be a lead free or a Sn—Ag—Cu based lead free. Such a low melting-point lead may be employed to form the solder 270 for joining the connection wire 230 with the magnet terminal 210. Otherwise, for allowing a normal lead to be used for a soldering, it may be permissible to join the metal terminal 290 with the magnet terminal 210 by inserting and soldering the metal terminal 290, which is available for the soldering, between the magnet terminal 210 and the solder 270. It may be also permissible to join a metal with a magnet through a shrinkable tube.

The connection wire 230 may transfer an electric signal between the connection terminal 250 and the magnet terminal 210. As shown in FIG. 4, the connection wire 230 may include a flexible electric wire 233 and a rigid electric wire 231. The rigid electric wire 231 may be formed to be hardly flexible and the flexible electric wire 233 may be variably shaped by a user. The rigid electric wire 231 may be formed to transfer an electric signal between the solder 270 and the flexible electric wire 233. The flexible electric wire 233 may be formed to transfer an electric signal between the connection terminal 250 and the rigid electric wires 231.

The connection terminal 250 may be used as a terminal to be connected with an element which is employed for circuit formation in the bread board 100. The connection terminal 250 may be connected with a terminal of an element to transfer an electric signal. The connection terminal 250 may be formed in a male type or a female type.

As described above, the bread boards 100 of FIGS. 2 and 3 and one or more jumper wires 200 of FIG. 4 may be employed to form and distribute education kits. These education kits may be used for design education of electric circuits in the form of sets. An education kit may include the bread board 100 and the jumper wire 200, other materials as well.

A user handling such an education kit is able to directly recognize a feature of connection configuration from a pattern of the conductive pads 130 of the bread board 100. Accordingly, the user is able to easily set the jumper wires 200 in the bread board 100 through the magnet terminals 210 of the jumper wires 200, without additional connection set manipulations, and to connect the jumper wires 200 with other elements.

A bread board, a bread-board specific jumper wire, and an education kit may be employed in various applications. For example, a bread board, a bread-board specific jumper wire, and an education kit may be applicable to physical computing education and Arduino education, as well as for practical exercise equipment, and may be utilized for educations of circuits and embedded systems to beginners.

While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A bread board comprising:
a metal layer joinable with a magnet;
an insulation layer placed on the metal layer; and
a plurality of conductive pads placed on the insulation layer.

2. The bread board of claim 1, wherein the metal layer comprises
a tin, the insulation layer comprises a synthetic resin, and the conductive pads comprises a nonferrous metal,
wherein the metal layer and the insulation layer are directly joined each other.

3. The bread board of claim 1, wherein each width of the plurality of conductive pads is formed in a specific width and an interval between adjacent conductive pads is larger than the specific width.

4. The bread board of claim 3, wherein a jumper wire comprising a magnet terminal is joinable the metal layer joined to the conductive pads.

5. A bread-board specific jumper wire comprising:
a magnet terminal;
a connection wire configured to conduct an electrical signal with the magnet terminal; and
a connection terminal configured to conduct an electric signal with the connection wire.

6. The bread-board specific jumper wire of claim 5, further comprising a solder through which the magnet terminal and the connection wire transfer an electric signal, the solder being made by a low melting-point soldering.

7. The bread-board specific jumper wire of claim 6, wherein the connection wires comprises:
a rigid electric wire configured to transfer an electric signal to the solder; and
a flexible electric wire configured to transfer an electric signal between the rigid electric wire and the connection terminal.

8. An education kit comprising the bread board of claim 1 and the bread-board specific jumper wire of claim 5.
